(19) United States
(12) Patent Application Publication
(10) Pub. No.: US 2023/0033005 A1
(43) Pub. Date: Feb. 2, 2023

(54) Method for the Operation of a Motor Vehicle at a Venue, in particular in a Drive-In Cinema

(71) Applicant: Ford Global Technologies, LLC, Dearborn, MI (US)

(72) Inventors: Esra Demirhan, Cologne (DE); Julian Gerber, Koeln (DE); Daniela Rauhut, Koln (DE); Marc Roeber, Dusseldorf (DE); Kujtim Shala, Bruhl (DE); Florian Vieten, Meerbusch (DE)

(73) Assignee: Ford Global Technologies, LLC, Dearborn, MI (US)

(21) Appl. No.: 17/815,275

(22) Filed: Jul. 27, 2022

(30) Foreign Application Priority Data
Jul. 29, 2021 (DE) 102021119809.7

(51) Int. Cl. B60G 17/017

(52) U.S. Cl. CPC B60G 17/017; B60G 2500/324; B60G 2800/20; B60G 2400/30

(57) ABSTRACT

The disclosure relates to systems and methods for operating a motor vehicle at an event venue, in particular in a drive-in cinema, which may include the steps of reading vehicle data (FD) indicative of a current position of the motor vehicle at a venue, and changing to an event operating mode to operate the motor vehicle (6) during an event at the venue if the vehicle data (FD) are indicative of a current position of the motor vehicle (6) at the venue.

### CROSS-REFERENCE TO RELATED PATENT APPLICATION

The present application claims priority to and the benefit of German Application No. 102021119809.7, filed Jul. 29, 2021, which is hereby incorporated by reference herein its entirety.

### FIELD OF THE INVENTION

The invention relates to a method for operating a motor vehicle at a venue, in particular in a drive-in cinema.

### BACKGROUND

A drive-in cinema is an open-air cinema, the screen of which can be seen from the motor vehicles on the respective designated parking spaces in the drive-in cinema.

The sound is transmitted during screening of the film, for example via a VKM or FM frequency and can be reproduced with the car radio of a vehicle's own infotainment system (also IVI— in-vehicle infotainment) of the vehicle.

However, the infotainment systems of modern motor vehicles have presets that cause the infotainment system to automatically switch itself off immediately or after a predetermined period of time, for example 30 minutes. In some cases, manual switching on again allows operation with a maximum total operating time of one hour. This means that during a film screening, which usually lasts at least 90 minutes, the infotainment system switches off automatically several times and can ultimately only be put back into operation by switching on the vehicle ignition. Furthermore, in modern motor vehicles, a daytime running light is switched on at the same time as the vehicle ignition is switched on, for example, which can interfere with the image reproduction on the screen of the drive-in cinema. This requires manual covering of the headlights of the motor vehicle.

From U.S. Pat. No. 3,706,006 A it is known to change an operating mode or vehicle settings of a motor vehicle located in a drive-in cinema.

From U.S. Pat. No. 9,969,319 B2, US 2018/0056745 A, U.S. Pat. No. 8,358,074 B2 and CN 201927190 U it is known to determine the position of the motor vehicle from GPS data or by evaluating environment data of the motor vehicle.

There is therefore a need to show ways in which this can be remedied.

### BRIEF DESCRIPTION OF THE DRAWINGS

The invention is now explained on the basis of a drawing. In the figures:

FIG. 1 shows a motor vehicle in a drive-in cinema in a schematic representation.

FIG. 2 shows a first screen view of an HMI of the motor vehicle shown in FIG. 1 in a schematic representation.

FIG. 3 shows a further screen view of an HMI of the motor vehicle shown in FIG. 1 in a schematic representation.

FIG. 4 shows a further screen view of an HMI of the motor vehicle shown in FIG. 1 in a schematic representation.

FIG. 5 shows a further screen view of an HMI of the motor vehicle shown in FIG. 1 in a schematic representation.

FIG. 6 shows a process sequence for the operation of the motor vehicle shown in FIG. 1 in a schematic representation.

### DETAILED DESCRIPTION

An object of the invention is achieved by a method for operating a motor vehicle at a venue, in particular in a drive-in cinema, with the steps:

reading vehicle data indicative of a current position of the motor vehicle at the venue, and

changing to an event operating mode to operate the motor vehicle during an event at the venue if the vehicle data are indicative of a current position of the motor vehicle at the venue.

Thus, an automatic change from a normal operating mode to a special event operating mode is achieved, in which the motor vehicle is set up for operation especially during the duration of the event. Thus, for example, uninterrupted enjoyment of a film can be made possible and elaborate actions or changes, especially to the motor vehicle itself, are not required.

According to one embodiment, the vehicle data include operating data indicative of a standstill of the motor vehicle and/or position data indicative of a current position of the motor vehicle and/or environment data indicative of the environment of the motor vehicle. The operating data indicative of a standstill may be data indicating that a traction motor of the motor vehicle has been deactivated and/or a parking brake has been activated and/or a vehicle transmission is idling or in neutral. The position data indicative of a current position of the motor vehicle can be navigation data of a satellite navigation system, such as for example GPS, which are also used by a navigation system of the motor vehicle. The environment data are provided by the vehicle's environment sensors. These can be, for example radar, lidar, ultrasonic sensors and/or camera systems that provide the environment data for driver assistance systems of the motor vehicle. By recording and evaluating the position and orientation of adjacent motor vehicles in relation to a screen of the drive-in cinema, it is possible to determine whether the motor vehicle is in a drive-in cinema. For example, it is possible to determine whether the motor vehicle is in a drive-in cinema by recourse to in-vehicle data. Further additional components, however, are not required.

According to a further embodiment, changing to the event operating mode includes a user query. For example, an HMI of the vehicle's infotainment system in the form of a display or touchscreen is used to output a corresponding image data set, with which the user is asked to confirm or reject a change to the event operating mode. This avoids an unwanted change to the event operating mode.

According to a further embodiment, in the event operating mode a traction engine of the motor vehicle is deactivated and/or the ignition of the motor vehicle is switched on and/or the vehicle lighting of the motor vehicle is deactivated and/or predetermined components of the motor vehicle are disconnected from an operating power supply and/or an infotainment system of the motor vehicle is put into a surround sound mode and/or an infotainment system of the motor vehicle is put into an event mode and/or vehicle parameters of the motor vehicle are changed. On the one hand, it can be achieved that the capacity of the vehicle battery is not exhausted before the end of the event. On the other hand, components of the vehicle lighting do not interfere with the film experience, while other components are operated advantageously for this purpose.

According to a further embodiment, the motor vehicle returns to a normal operating mode on detection of the end of an event, in particular the end of a film, and/or on the detection of a signal representing the end of a film, and/or in response to a manual user input. Thus, an automatic change from the special event operating mode to the normal operating mode is achieved, for example in that the end credits of the film or the end of the film itself are detected. Alternatively or additionally, this can be done on the reception of a signal that is sent from the drive-in cinema to the motor vehicles in the drive-in cinema after the end of the film screening. By for example a manual user input or starting the traction engine of the motor vehicle, it is also possible to prematurely switch to normal operating mode.

Furthermore, the invention includes a computer program product designed to perform such a method, an infotainment system, and a motor vehicle with such an infotainment system.

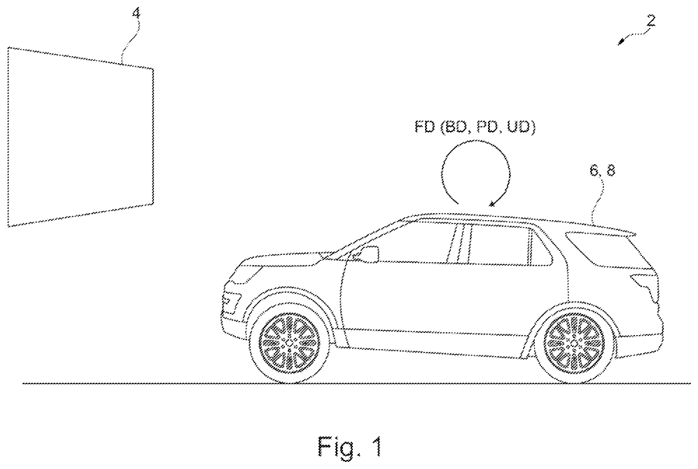

With reference to FIG. 1, a motor vehicle 6, in the present exemplary embodiment a car, is shown at a venue. In the present exemplary embodiment, the venue is a drive-in cinema 2. In a difference from the present embodiment, the motor vehicle 6 may also be located at another event location, in which for example instead of an event, a car concert is taking place.

The drive-in cinema 2 has a screen 8 on which the images of a film are projected during a film screening and can then be seen from the motor vehicle 6 or by the users in the motor vehicle 6.

The sound is transmitted during screening of the film, for example via a UKW or FM frequency and can be played back with a car radio of a vehicle's own infotainment system 8 (also IVI— in-vehicle infotainment) of the vehicle 6. An infotainment system 8 is understood to mean a control unit that provides, for example, the functions of a car radio, a navigation system, a hands-free system, driver assistance systems and other functions.

The infotainment system 8 of the motor vehicle 6 can have correspondingly designed computer hardware, processor, memory and/or software components for implementing these described tasks and functions. For instance, the processor may execute software to provide the described tasks and functions described herein.

In order to enable, for example in the case of a film screening, uninterrupted film enjoyment without elaborate actions or changes, in particular to the motor vehicle 6 itself, the infotainment system 8 is designed to read vehicle data FD indicative of a current position of the motor vehicle 6 in the drive-in cinema 2 and to change to the event operating mode for the operation of the motor vehicle 6 during a film screening in the drive-in cinema 2 if the vehicle data FD are indicative of a current position of the motor vehicle 6 in a drive-in cinema 2. For this and for the tasks and/or functions described below, the motor vehicle 6 with the infotainment system 8 may have appropriately designed hardware and/or software components.

In the present exemplary embodiment, the vehicle data FD include operating data BD indicative of a standstill of the motor vehicle 6 and/or position data PD indicative of a current position of the motor vehicle 6 and/or environment data UD indicative of an environment of the motor vehicle 2.

The operating data BD are data that indicate that a traction engine of the motor vehicle 6 has been deactivated and/or a parking brake has been activated and/or a vehicle transmission is idling or in a neutral position. In other words, a permanent standstill of the motor vehicle 6 is detected in contrast to a stopover, for example at a traffic light. Such a stopover may mean that the motor vehicle 6 is in a drive-in cinema 2.

The position data PD are navigation data of the satellite-based navigation system of the motor vehicle. They can be linked to other data, such as POI (point-of-interest) data, which contain geoinformation about drive-in cinemas in order to determine whether the motor vehicle 6 is in the drive-in cinema 2 by comparing these data.

The environment data UD are provided by environment sensors of the motor vehicle 6. It can be, for example, radar, lidar, ultrasonic sensors and/or camera systems that provide the environment data UD for driver assistance systems of the motor vehicle 6. For example, the infotainment system 8 of the motor vehicle 5 may be designed to evaluate the environment data UD in order to determine the positions and orientations of neighboring motor vehicles in relation to the screen 4 of the drive-in cinema 2. If positioning and orientation of adjacent motor vehicles typical of drive-in cinemas 2 has been detected, it can be determined that the motor vehicle 6 is in the drive-in cinema 2.

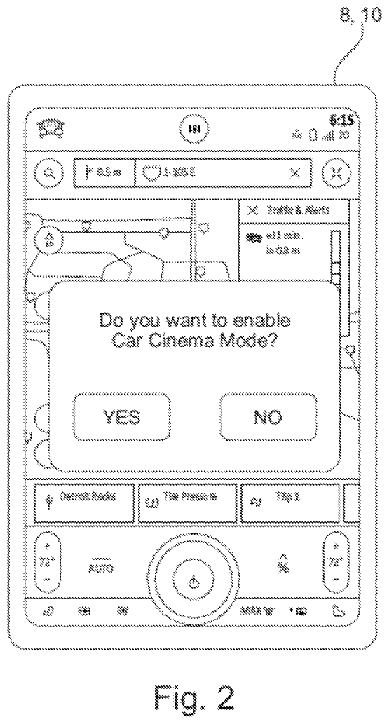

With reference to FIG. 2, it is shown that the infotainment system 8 in the present exemplary embodiment is designed to perform a user request to change to an event operating mode.

For this purpose, in the present exemplary embodiment, an HMI 10 of the infotainment system 8 in the form of a display or touchscreen visualizes a corresponding image data set to prompt a user to confirm or reject a change to the event operating mode.

If the user confirms the change to the event operating mode by for example a corresponding manual input with the HMI 10, in the present exemplary embodiment the infotainment system 8 causes by corresponding control signals a traction engine of the motor vehicle 6 to be deactivated and/or the ignition of the motor vehicle 6 to be switched on in such a way that according to a first stage (ACC) only a supply to the infotainment system 8 providing a radio function is carried out from a starter battery of the motor vehicle 6 and/or the vehicle lighting is deactivated including a daytime running light and/or taillights of the motor vehicle.

Furthermore, the infotainment system 8 causes by appropriate control signals predetermined components of the motor vehicle 6 to be disconnected from an operating power supply in order to reduce the energy consumption during screening of the film.

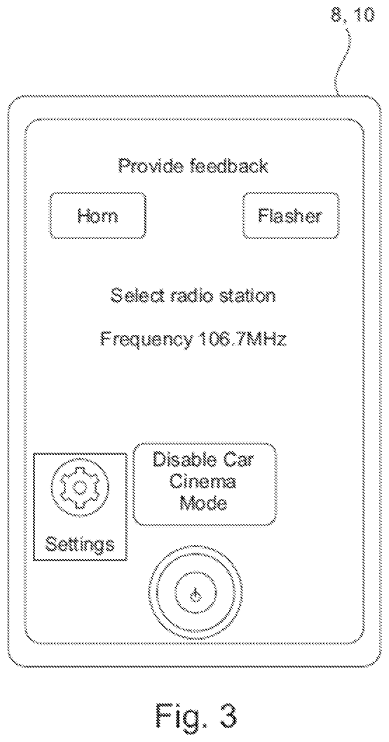

With reference to FIG. 3, it shows that a corresponding frequency selection is possible with the HMI 10 of the infotainment system 8. Furthermore, a horn or a headlight flasher of the motor vehicle 6 can also be operated.

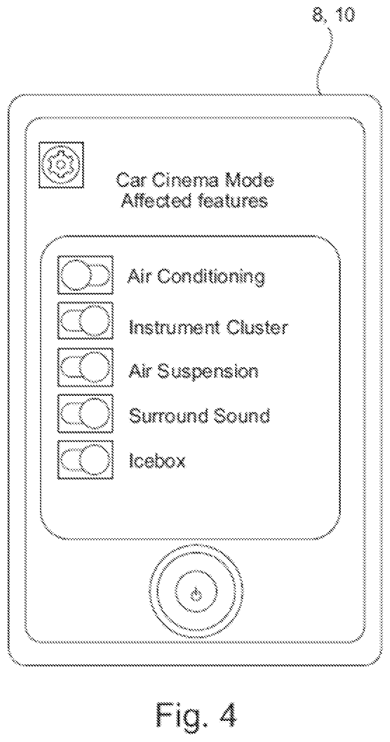

With reference to FIG. 4, in the present exemplary embodiment, the infotainment system 8 causes a change in vehicle parameters of the motor vehicle 6 by corresponding control signals.

In the present exemplary embodiment, the vehicle parameters can control/regulate the operation of an air conditioning system of the motor vehicle 6 and can influence the control of a combination device of the motor vehicle in order to prevent dazzling of the user during screening of the film by dimming the combination device.

Furthermore, vehicle parameters for a chassis adjustment can be changed so that the motor vehicle 6 can be lowered in the area of its rear axle, as shown in FIG. 1.

In the present exemplary embodiment, the infotainment system 8 causes by corresponding control signals a change of the infotainment system 8 into a surround sound mode and/or into an event mode to reproduce the sound belonging to the film screening with the motor vehicle's own loudspeakers.

Furthermore, it is provided in the present exemplary embodiment that a user is offered a selection of several channels via the HMI 10, wherein each channel is assigned a different language. In addition or alternatively, it may be provided in the present exemplary embodiment that in addition to the speech output with the selected channel the subtitles assigned to the channel are reproduced in a further, different language, for example with the HMI 10 and/or a head-up display of the motor vehicle 6.

Furthermore, it is provided in the present exemplary embodiment that a control data set, which is provided by the organizer, controls the infotainment system 8 in such a way that an automatic sound reproduction is set. This can mean an automatic frequency change, such as that the sound is transmitted via a UKW or FM frequency. It may also be provided that a transmission of the sound takes place via a web radio, in which audio data are continuously transmitted over the Internet. The audio data to be streamed can be provided for example via a normal web server (HTTP streaming). The infotainment system 8 then also has a software component in the form of a streaming client.

Furthermore, in the present exemplary embodiment, the operation of a cool box of the motor vehicle can be controlled/regulated.

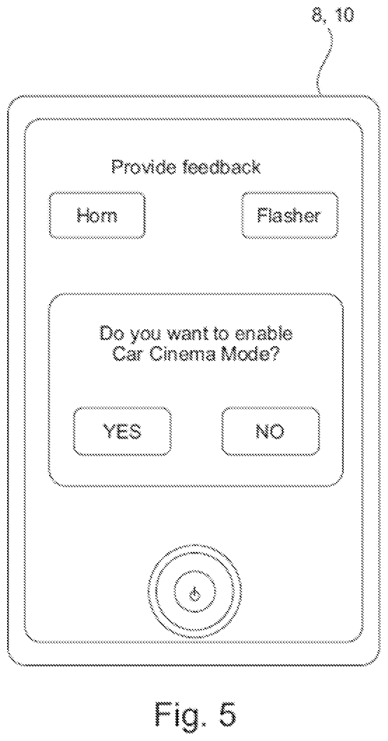

With reference to FIG. 5, in the present exemplary embodiment, the infotainment system 8 is designed to detect the end of an event, in particular the end of a film, and/or to detect a signal representing the end of a film, and/or to cause a return to a normal operating mode in response to a manual user input.

It is shown that a corresponding user input is possible with the HMI 10 of the infotainment system 8.

For this purpose, in the present exemplary embodiment, the HMI 10 of the infotainment system 8, which is in the form of a display or touchscreen, again visualizes a corresponding image data set to prompt a user to confirm or reject a return to the normal operating mode. This can again be in the form of a user request to return to the normal operation mode.

Furthermore, the infotainment system 6 with the HMI 8 may be designed to support the purchase of tickets for an event in the drive-in cinema 2 as well as the purchase of drinks and/or snacks.

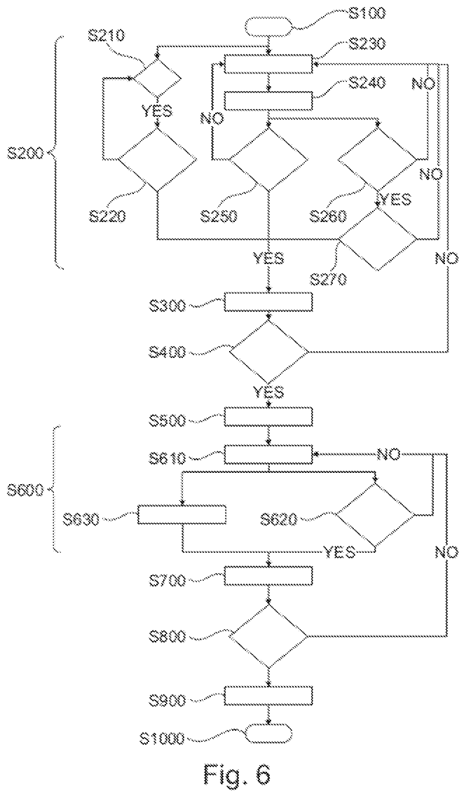

A method for the operation of the motor vehicle 6 is now explained with additional reference to FIG. 6.

The method starts in a first step S100, in which the vehicle data FD indicative of the current position of the motor vehicle 6 are read.

In a further step S200, the vehicle data FD are evaluated.

For this purpose, according to a first exemplary embodiment, the operating data BD of the vehicle data FD are evaluated in a first sub-step S210. It is determined, for example, whether the traction engine of the motor vehicle has been deactivated and/or the parking brake has been activated and/or the vehicle transmission is idling or in a neutral position.

If one or all or a predetermined selection of these conditions is met, the method is continued with a further sub-step S220.

In the further sub-step S220, it is queried whether there is a manual selection of the event operating mode. If this is the case, the method continues with the next step S300. Otherwise, the previous sub-step S210 is reverted to.

In a further sub-step S230, according to a further exemplary embodiment the operating data BD of the vehicle data FD are also evaluated to determine whether the motor vehicle 6 is still moving and is coming to a standstill.

In a further sub-step S240, the environment data UD are read in.

In a further sub-step S250, the position data PD are read in and it is determined whether the motor vehicle 6 is in a drive-in cinema 2 by a comparison of data related to POIs from maps.

If this is the case, the method continues with the next step S300.

Furthermore, in a further step S260, the environment data UD are evaluated to determine whether a screen 8 can be detected. If this is the case, the method is continued with another step S270. Otherwise, the sub-step S230 is reverted to.

In the further step S270, the environment data UD are evaluated to determine the respective positions and orientations of neighboring motor vehicles in relation to a screen 4 of the drive-in cinema 2. If the detected motor vehicles are for example evenly spaced and each with the same orientation, the method is continued with the further step S300. Otherwise, the sub-step S230 is returned to.

In the next step S300, the user request is carried out.

If in a further step S400 the user confirms the change to the event operating mode and the method is continued with another step S500. Otherwise, the sub-step S230 is returned to.

In the step S500 the change to the event operating mode takes place.

In a further step S600 monitoring now takes place to detect the end of a film.

For this purpose, in a first sub-step S610, the screen 4 is monitored for the end of a film itself, such as the credits and/or a signal representing the end of the film.

If the end of a film is detected in a further sub-step S620 for example, the method is continued with a step S700. Otherwise, it returns to step S610.

In a further sub-step S630, a check is carried out as to whether there is a manual user input with which a user wants to bring about a return to the normal operating mode. If such an input is present, the method is continued with a step S700. In addition or alternatively, it may also be provided that the detection of setting the motor vehicle 2 in motion, for example by detecting rotating wheels or a started traction engine, causes a return to the normal operating mode.

In a further step S700 another user query then takes place. If the user confirms the change from the event operating mode to the normal operating mode, the method is continued with a further step S800. Otherwise, it returns to step S600.

In the next step S900, the change to the normal operating mode takes place.

The method ends with a further step S1000.

In a difference from the present exemplary embodiment, the order of the steps and/or sub-steps may also be different. Furthermore, several steps and/or sub-steps can also be carried out at the same time or simultaneously. Furthermore, in a difference from the present exemplary embodiment, individual steps and/or sub-steps can be skipped or omitted.

Thus, an automatic change from a normal operating mode to a special event operating mode is achieved, in that the motor vehicle 6 is set up for operation specifically during the duration of the event such as a film screening. In this way, uninterrupted enjoyment of a film can be made possible and no elaborate actions or changes, especially on the motor vehicle 6 itself, are required.

It is claimed:

1. Method for the operation of a motor vehicle at a venue, in particular in a drive-in cinema, with the steps:
reading vehicle data (FD) indicative of a current position of the motor vehicle at the venue; and
changing to an event operating mode for the operation of the motor vehicle during an event at the venue if the vehicle data (FD) are indicative of a current position of the motor vehicle at the venues.

2. Method according to claim 1, wherein the vehicle data (FD) include at least one of operating data (BD) indicative of a standstill of the motor vehicle, position data (PD) indicative of a current position of the motor vehicle, or environment data (UD) indicative of an environment of the motor vehicle.

3. Method according to claim 1, wherein the change to the event operating mode includes a user request.

4. Method according to claim 1, wherein in the event operating mode a traction engine of the motor vehicle is deactivated, the ignition of the motor vehicle is switched on, vehicle lighting of the motor vehicle is deactivated, predetermined components of the motor vehicle are disconnected from an operating power supply, an infotainment system of the motor vehicle is put into a surround sound mode, an infotainment system of the motor vehicle is put into an event mode, or vehicle parameters of the motor vehicle are changed.

5. Method according to claim 1, wherein the motor vehicle returns to a normal operating mode on detection of the end of an event, in particular the end of a film, on detection of a signal representing the end of a film, or in response to a manual user input.

6. A computer program product designed to carry out a method according to claim 1.

7. An infotainment system for a motor vehicle, wherein the infotainment system is designed to read vehicle data (FD) indicative of a current position of the motor vehicle at a venue, and to change to an event operating mode for the operation of the motor vehicle during an event at the venue if the vehicle data (FD) is indicative of a current position of the motor vehicle at a venue.

8. The infotainment system according to claim 7, wherein the vehicle data (FD) include operating data (BD) indicative of a standstill of the motor vehicle, position data (PD) indicative of a current position of the motor vehicle, or environment data (UD) indicative of an environment of the motor vehicle.

9. The infotainment system according to claim 7, wherein the infotainment system is designed to carry out a user request to change to an event operating mode.

10. The infotainment system according to claim 7, wherein the infotainment system is designed to cause, in the event operating mode, the deactivation of a traction engine of the motor vehicle, the switching on of the ignition of the motor vehicle, deactivation of the vehicle illumination of the motor vehicle, the disconnection of predetermined components of the motor vehicle from an operating power supply, a change of the infotainment system of the motor vehicle to a surround sound mode, a change of the infotainment system of the motor vehicle to an event mode, or a change of vehicle parameters of the motor vehicle.

11. The infotainment system according to claim 7, wherein the infotainment system is designed to detect the end of an event.

12. The infotainment system according to claim 11, wherein the event is a film, and the end of the event is the end of the film, wherein detecting the end of the film comprises detecting a signal representing the end of a film.
